(19) United States
(12) Patent Application Publication
(10) Pub. No.: US 2012/0030133 A1
(43) Pub. Date: Feb. 2, 2012

(54) SYSTEMS AND METHODS FOR ARRANGING DELIVERY OF A PACKAGE

(76) Inventor: William B. Rademaker, Seattle, WA (US)

(21) Appl. No.: 13/037,220

(22) Filed: Feb. 28, 2011

Related U.S. Application Data
(60) Provisional application No. 61/308,850, filed on Feb. 26, 2010.

(51) Int. Cl. G06Q 30/00

(52) U.S. Cl. 705/333; 705/330

(57) ABSTRACT

A package delivery system and method that facilitates a meeting between a package recipient and a delivery vehicle. In one embodiment, the package recipient requests a rendezvous with the delivery vehicle after a failed delivery attempt. A vehicle operator or dispatching agent may accept the rendezvous request, deny the rendezvous request, or propose an alternative. If the rendezvous request is accepted, the package recipient may transmit a notification to the vehicle operator once the package recipient has arrived at the delivery vehicle so that the package may be picked up. Picking up the package from the delivery vehicle instead of waiting for a repeated delivery attempt helps to save costs associated with the repeated delivery, and helps the package recipient receive the package in a more timely manner.

### CROSS-REFERENCE TO RELATED APPLICATION

This application claims the benefit of Provisional Application No. 61/308,850, filed Feb. 26, 2010, the entire disclosure of which is hereby incorporated by reference herein.

### BACKGROUND

Web-based retail is fueling home delivery for products bought by consumers online. However, there exist some substantial flaws with traditional home-delivery services. Many merchants or delivery providers request a signature to accept delivery of a package, or for other reasons are unable to leave a package unsupervised. For package recipients who cannot arrange to wait at a planned delivery location during an often uncertain delivery window, delivery often fails due to such restrictions for leaving a package. Often, the recipient will return home to find a door tag indicating that a delivery service tried to deliver the package, but failed to do so.

The door tag often indicates that the delivery service will attempt redelivery at another time. Multiple attempts to deliver a package generate additional delivery costs for the delivery agent, including added fuel costs, time costs to deal with package backlogs, and the like. Further, the difficulties in delivering the package the first time are unlikely to be remedied on subsequent attempts, and so a successful redelivery attempt may not occur. A delivery company stands to reduce costs significantly by mitigating or reducing the problem of repeat delivery attempts.

The door tag may also indicate a central warehouse where the recipient can travel to pick up the package. However, the central warehouse is often located a great distance from the recipient, and so this solution is often inconvenient and costly. The waste of time and fuel in traveling to the central warehouse, along with the further delay in receipt of the package, undermines the purpose of home delivery.

What is needed is a solution that reduces repeated delivery attempts, thereby saving both a package delivery agent and a package recipient time and cost.

### SUMMARY

To address these issues, embodiments of the present disclosure allow a package recipient to arrange a rendezvous with a delivery vehicle at a point other than an originally scheduled delivery stop.

In one embodiment, a computer-implemented method for facilitating a rendezvous with a vehicle is provided. The method comprises receiving a rendezvous request from a rendezvous requester; determine whether to accept or reject the rendezvous request; and in response to a determination that the rendezvous request is accepted, transmitting the accepted rendezvous request to a computing device for presentation to a vehicle operator.

In another embodiment, a nontransitory computer-readable medium having computer-executable instructions stored thereon is provided. In response to execution by a processor of a computing device, the computer-executable instructions cause the computing device to perform actions for facilitating a rendezvous between a package recipient and a delivery vehicle. The actions comprise receiving a rendezvous request from the package recipient, the rendezvous request including a rendezvous location. A determination is made whether to accept or reject the rendezvous request. In response to a determination that the rendezvous request is accepted, the actions further comprise transmitting the accepted rendezvous request to a computing device associated with the delivery vehicle for presentation to a vehicle operator; receiving an arrival notification indicating that the package recipient has arrived at the rendezvous location; and transmitting the arrival notification to the computing device associated with the delivery vehicle for presentation to the vehicle operator.

In yet another embodiment, a system for facilitating package delivery is provided. The system comprises a processor, a computer-readable medium, and a set of computer-executable components stored on the computer-readable medium for execution by the processor. The computer-executable components include a dispatching engine that is configured to receive a rendezvous request from a package recipient and a rendezvous request response. The rendezvous request response indicates acceptance of the rendezvous request, rejection of the rendezvous request, an additional charge for acceptance of the rendezvous request, or an alternative rendezvous location. In response to a rendezvous request response indicating acceptance of the rendezvous request, the dispatching engine is configured to transmit an acceptance notification for presentation to the package recipient, track a location of the package recipient and a location of a delivery vehicle, and enable a notification interface button on a recipient interface device in response to determining that the location of the package recipient and the location of the delivery vehicle are within a predetermined distance of each other.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a problem in traditional delivery methods;

FIG. 2 illustrates package tracking information that may be made available to a package recipient by a traditional package delivery system;

FIG. 3 illustrates one embodiment of a delivery method that allows a package recipient to arrange to receive a package despite a delivery attempt failure, according to various embodiments of the present disclosure;

FIG. 4 illustrates an exemplary door slip that may be left at a delivery location by a vehicle operator after a filed delivery attempt according to various embodiments of the present disclosure;

FIG. 5 is a block diagram illustrating an exemplary delivery routing system according to various embodiments of the present disclosure;

FIG. 6 illustrates an exemplary rendezvous request interface according to various embodiments of the present disclosure;

FIG. 7 illustrates another exemplary rendezvous request interface according to various embodiments of the present disclosure;

FIGS. 8A and 8B illustrate an exemplary dispatching interface according to various embodiments of the present disclosure;

FIG. 9 illustrates an exemplary return on investment interface according to various embodiments of the present disclosure;

FIG. 10A illustrates an exemplary interface presented to a package recipient once the requested rendezvous has been accepted in order to facilitate the rendezvous, according to various embodiments of the present disclosure;

FIG. 10B illustrates an exemplary interface presented to a vehicle operator once an arrival notification has been generated and sent by the package recipient, according to various embodiments of the present disclosure; and

FIGS. 11A-11H are a flowchart illustrating an exemplary method of arranging a delivery according to various embodiments of the present disclosure.

### DETAILED DESCRIPTION

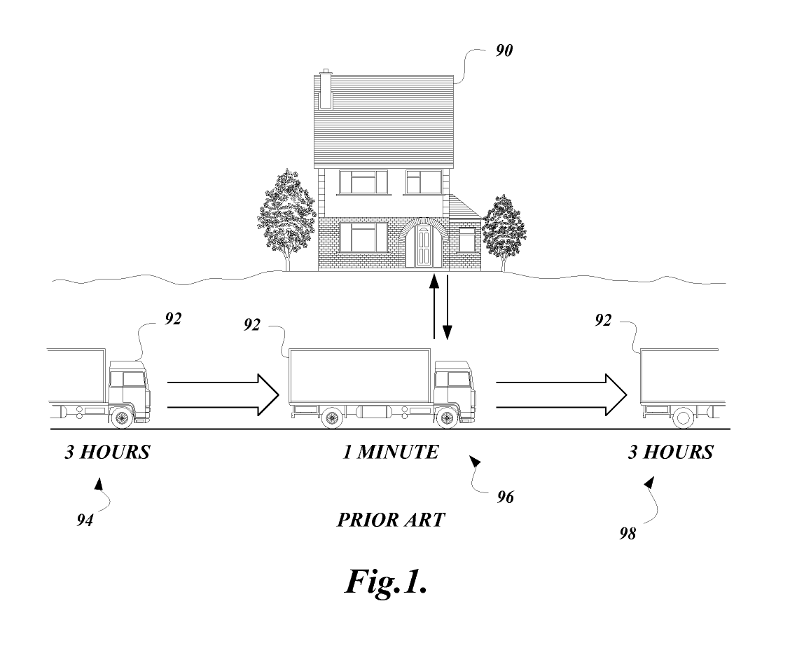

FIG. 1 provides a further illustration of problem discussed above in traditional delivery methods. A package recipient schedules delivery of a package to a delivery location 90. A delivery vehicle 92 is assigned a route that includes delivery of the package to the delivery location 90. The delivery vehicle 92 proceeds on a first portion of the delivery route 94, which may take a considerable amount of time, such as three hours.

The delivery vehicle 92 arrives at the delivery location 90, and an operator of the delivery vehicle 92 attempts to deliver the package. The operator may ring the doorbell, and find that no one is available to provide a signature indicating a successful delivery. Upon receiving no answer to the doorbell, the operator may indicate that the delivery attempt failed, leave a door slip indicating that delivery will be re-attempted, and continue to a second portion of the delivery route 98. Though the delivery vehicle 92 may retain the package throughout the second portion of the delivery route 98 for a long time (such as the illustrated three hours), if the package recipient is not available at the delivery location 90 for the brief time that the delivery vehicle 92 is present at the delivery location 90 (such as the illustrated one minute), the recipient has no option to obtain the package from the delivery vehicle 92.

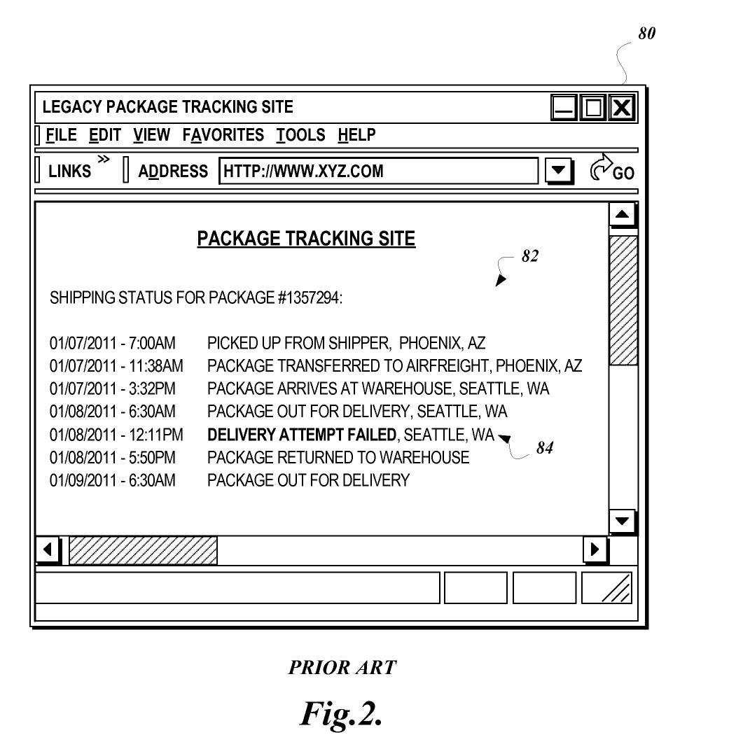

FIG. 2 illustrates tracking information that may be made available to a package recipient by a traditional package delivery system. The package recipient may have a tracking number that was transmitted to the package recipient while arranging the shipment. Alternatively, the package recipient may receive a tracking number via a door slip left by the operator of the delivery vehicle 92 during a failed delivery attempt. The package recipient enters the tracking number into a traditional package tracking interface 80, and is presented a plurality of delivery status notifications 82. The delivery status notifications 82 contain information outlining the path the package has traveled during shipment. Usually, the traditional package tracking interface 80 will merely present to the package recipient a delivery failure notice 84, but will not provide the package recipient any way to arrange to receive the package during the second portion of the delivery route 98.

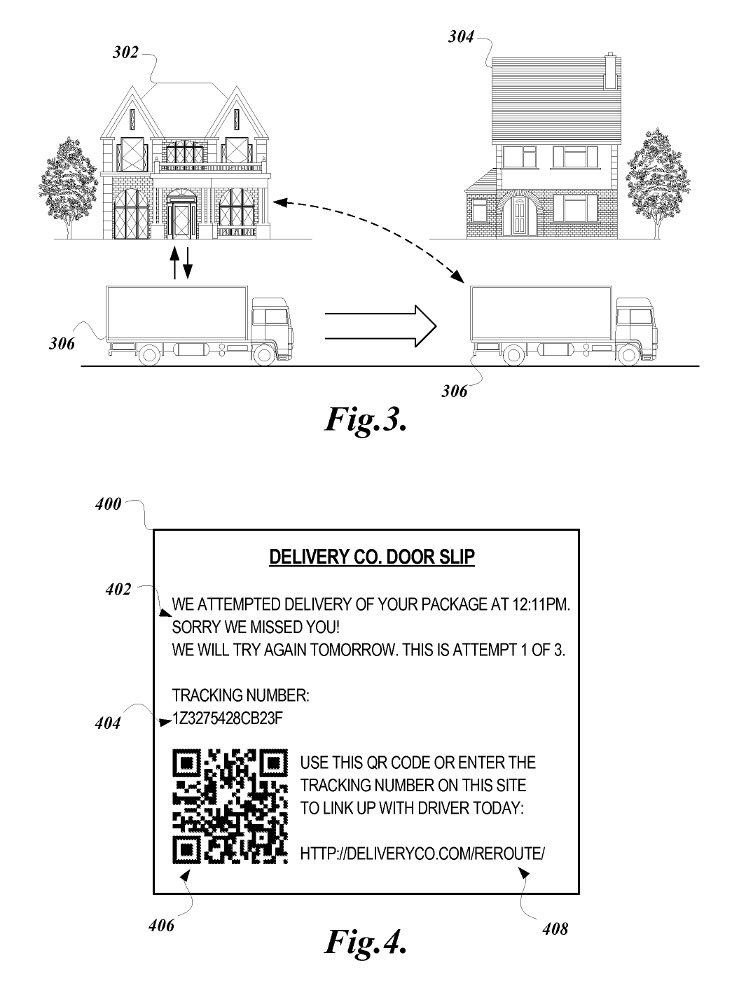

FIG. 3 is a conceptual illustration of a delivery method that allows a package recipient to arrange to receive a package despite a delivery attempt failure, according to various embodiments of the present disclosure. Similar to the illustrations above, a delivery vehicle 306 stops at a delivery location 302, and is unable to deliver the package in a reasonable amount of time. The delivery vehicle 306 then proceeds to a later delivery stop 304 in a route assigned to the delivery vehicle 306. In embodiments of the present disclosure, the package recipient may meet the delivery vehicle 306 at the later delivery stop 304, thus bypassing the need for subsequent delivery attempts. Systems and methods for coordinating this rendezvous according to various embodiments of the present disclosure will be discussed in detail below.

FIG. 4 illustrates a door slip 400 that may be left by a vehicle operator after a failed delivery attempt according to various embodiments of the present disclosure. In one embodiment, the door slip 400, once discovered, informs the package recipient that the failed delivery attempt occurred, and provides ways for the package recipient to obtain further information concerning the package. The door slip 400 includes delivery attempt information 402, which states a time when the delivery attempt occurred and information concerning how many additional delivery attempts will be made absent further recipient action.

The door slip 400 also includes a tracking number 404, a graphically encoded URL 406, and a text URL 408. The text URL 408 can be entered by the package recipient into a conventional web browser to navigate to a package tracking and rerouting interface. The package recipient may input the tracking number 404 into the package tracking and rerouting interface in order to further control delivery of the package, as will be described further below. The graphically encoded URL 406 may be represented by a two-dimensional bar code, as illustrated, but other types of encoding such as a linear bar code, a stacked bar code, and the like, may also be used. The graphically encoded URL 406 provides the package recipient with a way to navigate directly to a portion of the package tracking and rerouting interface relevant to the delivery of the package without requiring the manual input of the tracking number 404.

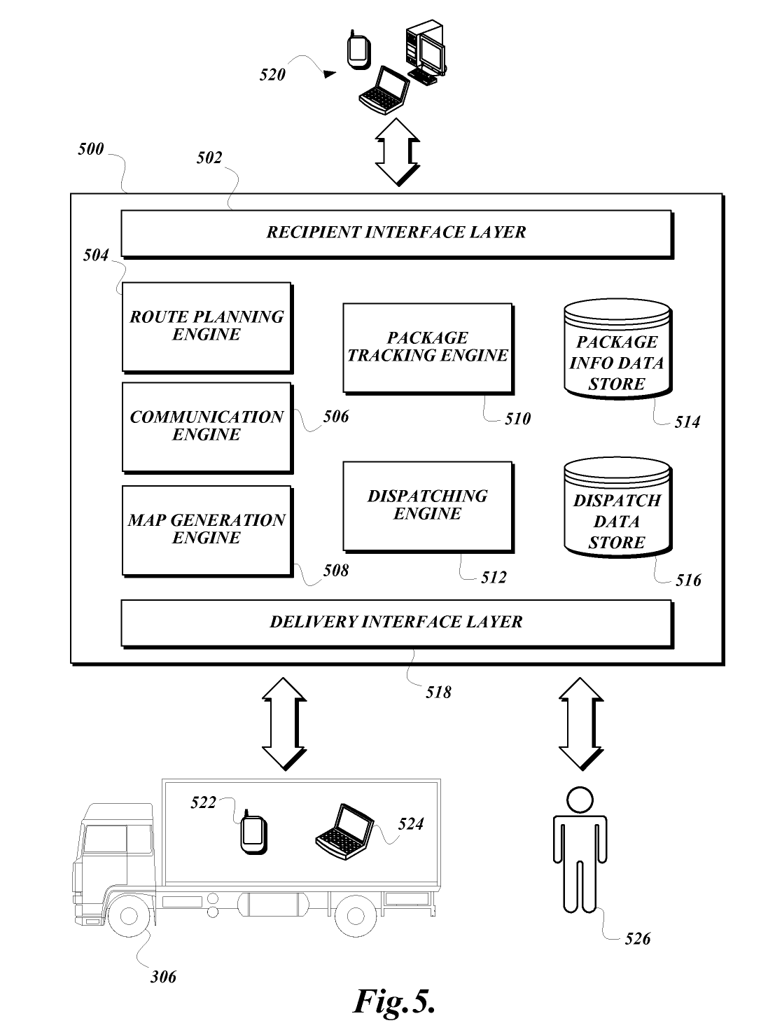

FIG. 5 illustrates a delivery routing system 500 according to various embodiments of the present disclosure. In one embodiment, the delivery routing system 500 is a computing device including at least one processor, a memory, a tangible computer-readable storage medium, and a network interface. One example of a suitable computing device for implementing the delivery routing system 500 is a rack-mount server computer. In other embodiments, other computing devices, such as a desktop computer, a laptop computer, a tablet computer, and the like could be used to implement the delivery routing system 500. In another embodiment, the functionality of the delivery routing system 500 may be provided by multiple discrete computing devices connected by a local area network or a wide area network. In yet another embodiment, the functionality of the delivery routing system 500 may be provided by program code executing on a cloud computing platform. The above examples of hardware suitable for implementing the delivery routing system 500 should be seen as exemplary and not limiting.

The delivery routing system 500 may include one or more engines, one or more data stores, and one or more layers. One embodiment of an “engine” as described herein includes computer-executable instructions stored on a tangible computer-readable medium that, when executed by one or more components of the delivery routing system 500 described above, cause the delivery routing system 500 to perform the actions described as taken by the particular engine. This description of an engine should be seen as exemplary and not limiting, as an engine may also include a particular computing device specifically programmed with computer-executable instructions that cause the computing device to perform the actions described as taken by the particular engine upon execution.

A “layer” is similar to an engine in most respects, except that a layer is more likely to serve as an intermediary between a client computing device and an engine of the delivery routing system 500. A “data store” is a structured set of data stored by a computing device and made accessible to engines and layers of the delivery routing system 500. In one embodiment, a data store may be a relational database management system executing on a component of the delivery routing system 500. In another embodiment, a data store may be a database management system executing on a computing device separate from the delivery routing system 500 that is accessed by the delivery routing system 500 over a network. Again, these descriptions of a data store should be seen as exemplary and not limiting.

The particular engines, data stores, and layers described below are exemplary and should not be seen as limiting. For example, functionality described as part of a single layer, engine, or data store may be split between multiple layers, engines or data stores without departing from the scope of the disclosure. Likewise, functionality described as part of multiple layers, engines, or data stores may be combined into a single layer, engine, or data store without departing from the scope of the disclosure.

In one embodiment, the delivery routing system 500 includes a recipient interface layer 502 and a delivery interface layer 518. The recipient interface layer 502 handles communication between the delivery routing system 500 and a recipient interface device 520. In one embodiment, the recipient interface layer 502 may provide an application programming interface, or API, through which an application executing on a recipient interface device 520 may communicate with various other components of the delivery routing system 500. In another embodiment, the recipient interface layer 502 may itself execute program logic to generate an interactive interface, such as a web page, which is then transmitted to a recipient interface device 520 for presentation.

In one embodiment, the recipient interface device 520 may be any type of computing device capable of communicating with the recipient interface layer 502 of the delivery routing system 500, and includes a processor, a memory, a network interface, and an input/output device. One example of a suitable recipient interface device 520 is a personal computer, which may interact with the recipient interface layer 502 via a standard web browser. Another example of a suitable recipient interface device 520 is a smart phone, which may interact with the recipient interface layer 502 via a mobile web browser or a custom application. A personal computer and a smart phone are examples of recipient interface devices 520 only, and should not be seen as limiting. Other computing devices, such as laptop computers, PDAs, tablet computers, and the like, are also within the scope of this disclosure.

The delivery interface layer 518 handles communication between the delivery routing system 500 and the delivery vehicle 306. As with the recipient interface layer 502, in one embodiment, the delivery interface layer 518 may provide an API through which the delivery vehicle 306 communicates with various components of the delivery routing system 500. In another embodiment, the delivery interface layer 518 may execute program logic to generate an interactive interface, such as a web page, which is then transmitted to the delivery vehicle 306 for presentation.

In the illustrated embodiment, the delivery vehicle 306 is a delivery truck. However, in other embodiments, the delivery vehicle 306 may be a different type of vehicle that performs a similar delivery function, such as a delivery van, a bicycle, a mail cart, and the like.

In one embodiment, the delivery vehicle 306 includes a vehicle interface device 524. The vehicle interface device 524 is logically associated with the delivery vehicle 306, and may be mounted permanently within the delivery vehicle 306. In one embodiment, the vehicle interface device 524 includes a processor, a memory, and a display for presenting route information, package information, and instructions to the vehicle operator. In one embodiment, the vehicle interface device 524 also includes one or more input devices for the vehicle operator to interact with the vehicle interface device 524, such as input buttons, a keyboard, a touch-sensitive input device such as a touchscreen, and the like. The input devices allow the vehicle operator to accept or refuse delivery rendezvous requests, to switch between multiple route and map views, and the like.

The vehicle interface device 524 includes a network interface device for communicating with the delivery interface layer 518 of the delivery routing system 500. In one embodiment, the network interface device communicates with the delivery routing system 500 over a wide-area wireless communication network, such as a cellular network, a 3G network, a WiMAX network, and the like. These examples should not be seen as limiting, as any suitable wireless network may be used with embodiments of the disclosed system.

In one embodiment, the delivery vehicle 306 is also associated with an operator interface device 522. The operator interface device 522 is logically associated with the vehicle operator, and may be carried on the person of the vehicle operator. In one embodiment, the operator interface device 524 includes a processor, a memory, a display, and one or more input devices for the vehicle operator to interact with an interface presented by the operator interface device 524. In one embodiment, the operator interface device 524 also includes a printer for generating receipts, door slips such as door slip 400, and the like. The operator interface device 524 may also include an optical input device such as a camera or a laser scanner for reading information from package labels, so that the operator need not manually enter such information.

The operator interface device 522 also includes a network interface device for communicating with the delivery routing system 500. The operator interface device 522 may communicate directly with the delivery interface layer 518 via a wide-area wireless communication network, such as a cellular network, a 3G network, a WiMAX network, and the like. In another embodiment, the operator interface device 522 may communicate with the vehicle interface device 524 via a local network such as a LAN, a WiFi network, a Bluetooth network, a physical connection such as USB, or the like. In this embodiment, the vehicle interface device 524 would communicate with the delivery interface layer 518, and would then transmit the necessary data locally to the vehicle interface device 524.

For purposes of discussion herein, it will be assumed that the vehicle interface device 524 is a single computing device that is permanently mounted within the delivery vehicle 306, and the operator interface device 522 is a single computing device carried by the vehicle operator. However, in one embodiment, the operator interface device 522 and the vehicle interface device 524 may be combined into a single computing device associated with the operator or the vehicle. In another embodiment, functionality of the operator interface device 522, the vehicle interface device 524, or both may be split among multiple distinct computing devices.

In one embodiment, the delivery routing system 500 may include a package information data store 514 and a dispatch data store 516. The package information data store 514 includes information regarding status of packages. For example, for a given package, the package information data store 514 may store a destination associated with the package, a currently location of the package, a plurality of status notifications similar to those illustrated in FIG. 2, and the like. The dispatch data store 516 includes information regarding planned routes for delivery vehicles. For example, for a given delivery vehicle, the dispatch data store 516 may include information associating one or more packages with the delivery vehicle, one or more scheduled delivery stops for the delivery vehicle, a suggested route for the delivery vehicle, and the like.

In one embodiment, the delivery routing system 500 may include a route planning engine 504, a communication engine 506, a map generation engine 508, a package tracking engine 510, and a dispatching engine 512. The package tracking engine 510 stores and updates information within the package information data store 514 in response to receiving notification that the status of the package delivery has changed. For instance, upon receiving notification that a package has been loaded on a delivery vehicle, the package tracking engine 510 stores a record within the package information data store 514 indicating that the package was loaded on the delivery vehicle. The dispatching engine 512 executes logic related to scheduling delivery stops for a delivery vehicle. The dispatching engine 512 stores and updates information relating to the scheduled delivery stops for the delivery vehicle, along with information relating to the recommended route for the delivery vehicle, in the dispatch data store 516.

The route planning engine 504 interacts with the dispatching engine 512 to generate a preferred delivery route for a delivery vehicle. The route planning engine 504 receives one or more delivery stops from the dispatching engine 512 and generates a route to be presented to the vehicle operator that encompasses each of the delivery stops, along with a start point and an end point. In one embodiment, the route is presented to the vehicle operator superimposed on a map, as is common with GPS navigation systems. In one embodiment, the route planning engine 504 may contain logic and navigation data sufficient for the route planning engine 504 to autonomously calculate a preferred route. In another embodiment, the route planning engine 504 may consult a third-party data source to obtain the preferred route.

The map generation engine 508 receives requests for maps, and generates map information responsive to those requests. For example, the delivery interface layer 518 may receive a request from a vehicle operator to display a map that displays an area in the vicinity of the delivery vehicle. The map generation engine 508 may generate a visual representation of the area in the vicinity of the delivery vehicle, and transmit the representation to the delivery interface layer 518 for transmission to the delivery vehicle. As with the route planning engine 504, one embodiment of the map generation engine 508 may possess sufficient map data to autonomously generate maps for a given request, while another embodiment of the map generation engine 508 may obtain map information for a given request from a third-party data source.

As described below, the delivery routing system 500 allows the package recipient to communicate with the vehicle operator to arrange for alternate package pickup. In one embodiment, this communication is facilitated by the communication engine 506, which tracks incoming requests from package recipients, and matches them to acceptances or rejections received by the delivery interface layer 518.

In one embodiment, the delivery interface layer 518 also handles communication between the delivery routing system 500 and a dispatching agent 526. The discussion below will, for simplicity's sake, focus primarily on an embodiment in which the vehicle operator uses the operator interface device 522 and the vehicle interface device 524 to communicate with a package recipient and to accept or reject newly requested delivery stops, thereby omitting the dispatching agent 526. However, in another embodiment, the dispatching agent 526, instead of the vehicle operator, may interact with the delivery routing system 500 to accept or reject requested delivery stops, and to request preferred routes from the route planning engine 504. Delivery stops and altered routes accepted by the dispatching agent 526 on behalf of the vehicle operator would then be presented to the vehicle operator via the vehicle interface device 524 or the operator interface device 522.

The actions described above for each engine are a nonlimiting overview of the functionality of each engine. Further description of the actions performed by each of the engines in various embodiments of the present disclosure is provided below.

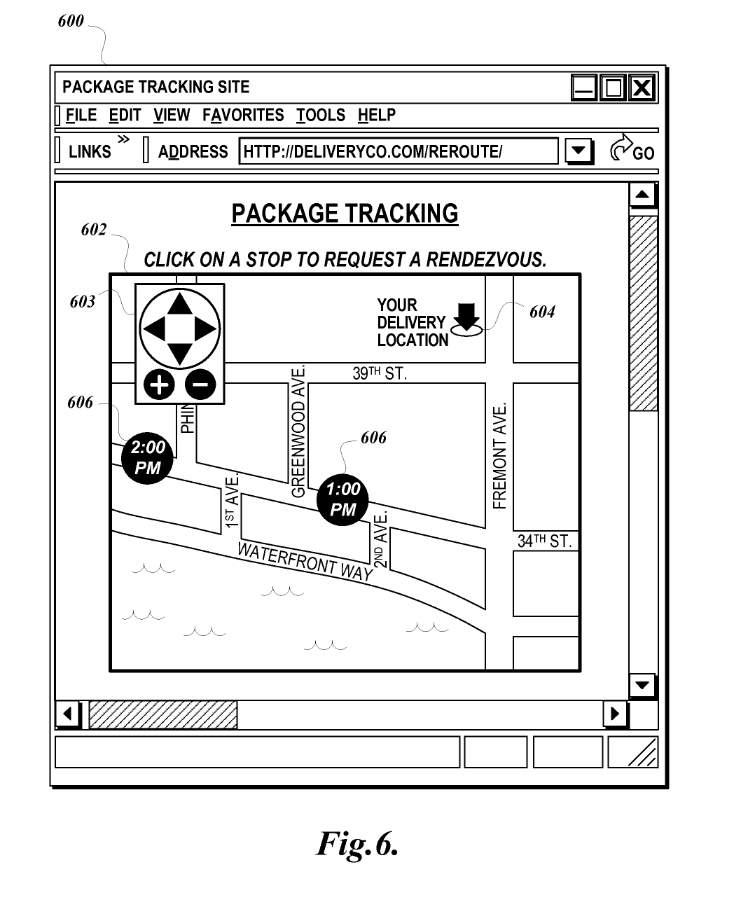

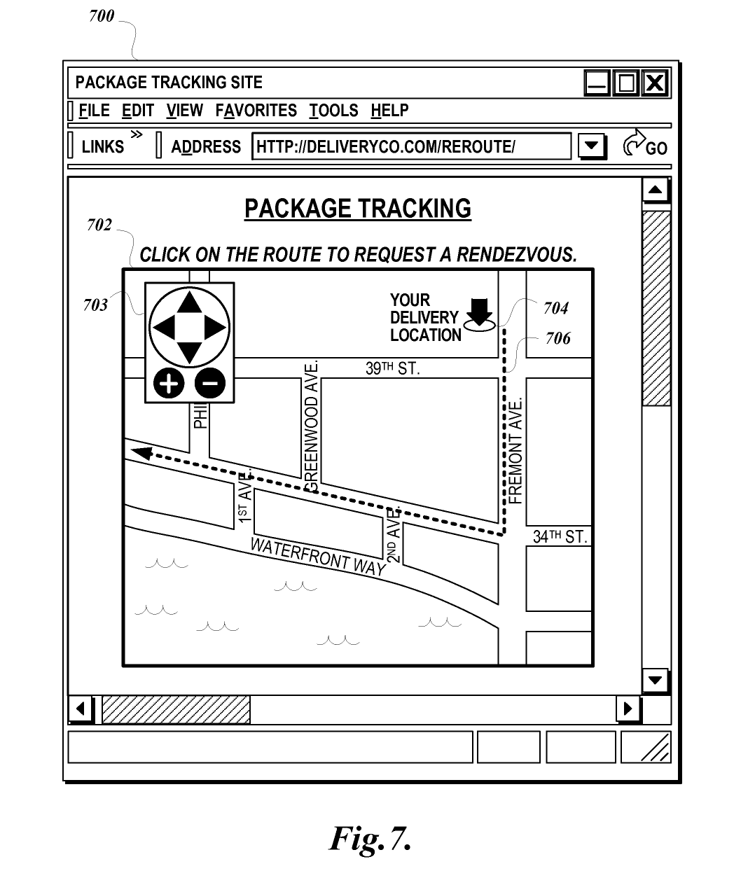

FIG. 6 illustrates a rendezvous request interface 600 according to various embodiments of the present disclosure. A package recipient may navigate to the illustrated interface by inputting, into a recipient interface device 520, information provided on the door slip 400 after a failed delivery attempt. For example, the package recipient may input the text URL 408 and tracking number 404 printed on the door slip 400 into a standard web browser executing on the recipient interface device 520 to bring up the rendezvous request interface 600. In another embodiment, the package recipient may input the tracking number 404 into a custom application executing on the recipient interface device 500, or may capture the graphically encoded URL 406 using a custom application executing on the recipient interface device 500.

The rendezvous request interface 600 includes a map 602 provided by the map generation engine 508. The map 602 includes the original delivery location 604, along with several later stop locations 606. The later stop locations 606 are locations at which the delivery vehicle is expected to stop in a portion of the delivery route after the original delivery location 604. As illustrated, the later stop locations 606 may also include an indication of a time at which the delivery vehicle is expected to arrive at the location, and may also include an indication of a time at which the delivery vehicle is expected to depart from the location. In one embodiment, the times associated with the later stop locations 606 may be predicted by an algorithm that takes into account the current location of the delivery vehicle 306, other stop locations, transient traffic and weather conditions, historical traffic conditions, topography, road conditions, and the like.

Though not illustrated, the icons denoting the later stop locations 606 may include additional information concerning the stop locations, such as whether a given stop location is available for rendezvous requests, or a likelihood that a rendezvous request for a given stop will be accepted. In one embodiment, this information may be communicated through an icon resembling a traffic light, with various colors indicating the likelihood of a successful rendezvous request for the associated stop. If the package recipient selects one of the later stop locations 606, a request to meet the delivery vehicle at the selected stop location is generated and transmitted to the dispatching engine 512 for further processing as discussed below.

In one embodiment, all of the later stop locations 606 for the rest of the route may be displayed. In another embodiment, the rendezvous request interface 600 may present the package recipient with only a few later stop locations 606 selected from all of the later stop locations on the route, so that the actual route of the delivery vehicle may be hidden. The package recipient may then request a rendezvous at one of the displayed later stop locations during a given time window.

In one embodiment, the map generation engine 508 generates a map 602 that includes the original delivery location 604. The map 602 may be centered on the original delivery location 604 and show an area of a default radius around the original delivery location 604. In another embodiment, the map 602 may include the original delivery location 604, but may be scaled and located to also include one or more later stop locations 606. If acceptable later stop locations 606 are not visible, the package recipient may use navigation interface buttons 603 to move or resize the map 602.

FIG. 7 illustrates another embodiment of the rendezvous request interface 700. This embodiment of the rendezvous request interface 700 includes a map 702, navigation interface buttons 703, and an original delivery location 704 similar to those illustrated and described above with respect to FIG. 6. However, instead of discrete later stop locations 606, the rendezvous request interface 700 shows a delivery route 706 the delivery vehicle is expected to travel upon after the original delivery location 704. The rendezvous request interface 700 may include time posts (not pictured) which show times at which the delivery vehicle 306 is expected to arrive at particular locations on the delivery route 706. The package recipient may select any location along the delivery route 706, and a request to meet the delivery vehicle at the specified location along the route is generated and transmitted to the dispatching engine 512 for further processing as discussed below.

In one embodiment, the rendezvous request interface 700 may also include an indication of a current location of the delivery vehicle 306. However, publicizing the location of the delivery vehicle 306 may pose a risk to a delivery vehicle 306 that is known to be carrying particularly valuable packages, or is known to be visiting one or more sensitive delivery stops. Accordingly, in one embodiment, the delivery routing system 500 allows the vehicle operator or the dispatching agent 526 to specify one or more areas along the delivery route 608, or one or more discrete stop locations 606, to be obscured in some way. For example, the location of the stop may be displayed, but the time of arrival or departure may be redacted. As another example, a portion of the route 608 may be hidden by superimposing an opaque graphic of a cloud, by illustrating the route 608 as taking a direct path from a point before the hidden portion to a point after the hidden portion, or the like.

In one embodiment, access to the rendezvous request interface 700 for a given delivery vehicle 306 may be restricted to package recipients who are associated with a package actually carried by the given delivery vehicle 306, so that the number of individuals with access to the vehicle location information is kept to a minimum. Access to the rendezvous request interface 700 may be limited to less than all of the package recipients who are associated with packages carried by the given delivery vehicle 306. For example, the delivery routing system 500 may exclude “problem” package recipients, high-risk package recipients, package recipients who are not members of a loyalty club, or for any other reason. In one embodiment, delivery vehicle location information may be made available by the delivery routing system 500 to the general public for certain delivery vehicles or at certain points in the route, so that individuals may locate the delivery vehicle as a point to give a package to the vehicle operator for shipping from the individual to a third party.

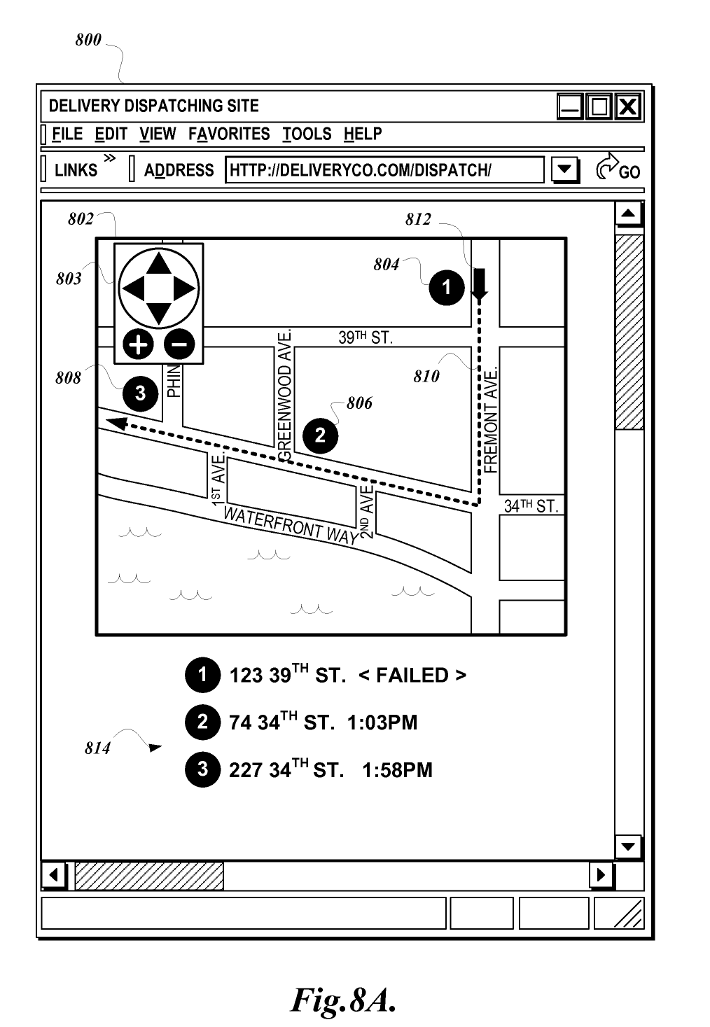

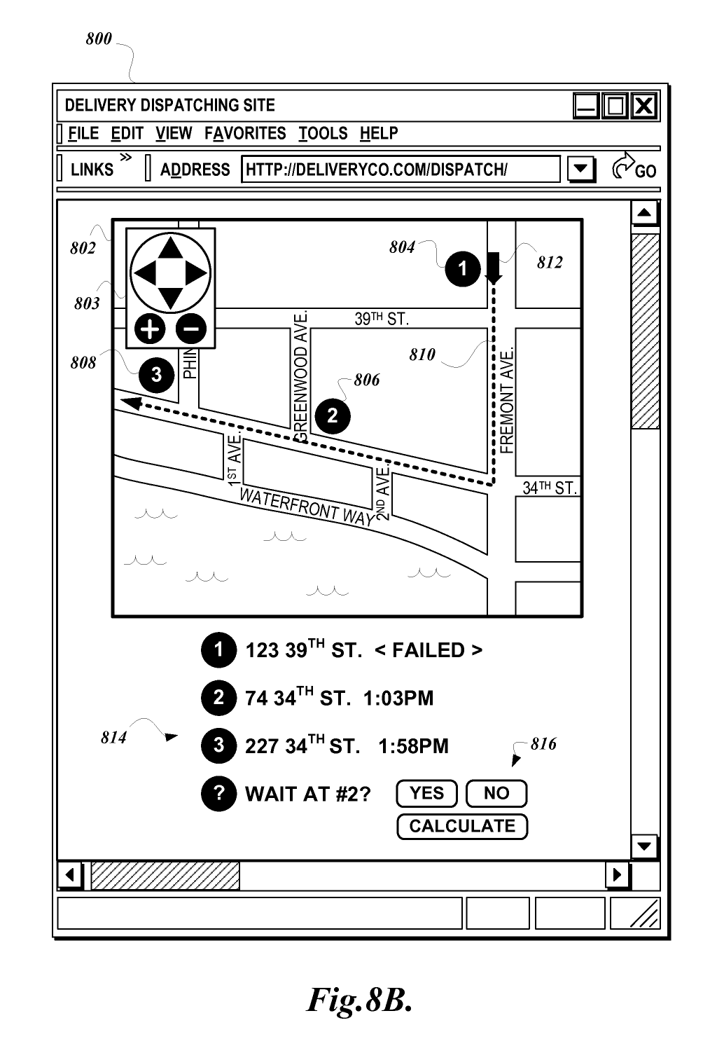

FIG. 8A illustrates an exemplary dispatching interface 800 according to various embodiments of the present disclosure. The dispatching interface 800 may be displayed by the vehicle interface device 524, or may be accessed by a dispatching agent 526 at a remote location. The dispatching interface 800 includes a map 802 and a set of navigation interface buttons 803 for moving and resizing the map 802. The dispatching interface 800 is illustrated as displaying information related to the same package delivery scenario illustrated in FIGS. 6 and 7. That is, the delivery vehicle 306 is at a first stop location 804, and the delivery at that location has failed. A second stop location 806 and a third stop location 808 are also shown, as well as a planned route 810 that travels past each of the stop locations. The current location of the delivery vehicle 306 is shown on the map 802 by a delivery vehicle location indicator 812.

The dispatching interface 800 also includes a stop location list 814. For each stop location along the planned route 810, the stop location list 814 displays relevant information, such as the address, an expected time of arrival, a status of past delivery attempts, and the like. For example, the stop location list 814 indicates the address of the first stop location 804 and that the delivery attempt failed. The stop location list 814 also indicates the address of the second stop location 806 and the third stop location 808, and the expected time of arrival at each stop location.

FIG. 8B illustrates the exemplary dispatching interface 800 after the delivery routing system 500 received a request from the package recipient for a rendezvous at the second stop location 806. In the illustrated example, the package recipient requested to meet the delivery vehicle 306 at the second stop location 806, such as by selecting the second stop location 806 via the rendezvous request interface 600 illustrated in FIG. 6. The stop location list 814 includes an entry for the requested rendezvous, along with a set of new stop interface buttons 816. The new stop interface buttons 816 allow the vehicle operator or the dispatching agent 526 to accept the request or to deny the request. In one embodiment, the new stop interface buttons 816 also allow the vehicle operator or the dispatching agent 526 to cause information regarding the cost of the rendezvous to be displayed. If the rendezvous is denied, the new entry will be removed from the stop location list 814. If the rendezvous is accepted, the new entry will be added to the route 810 and the stop location list 814.

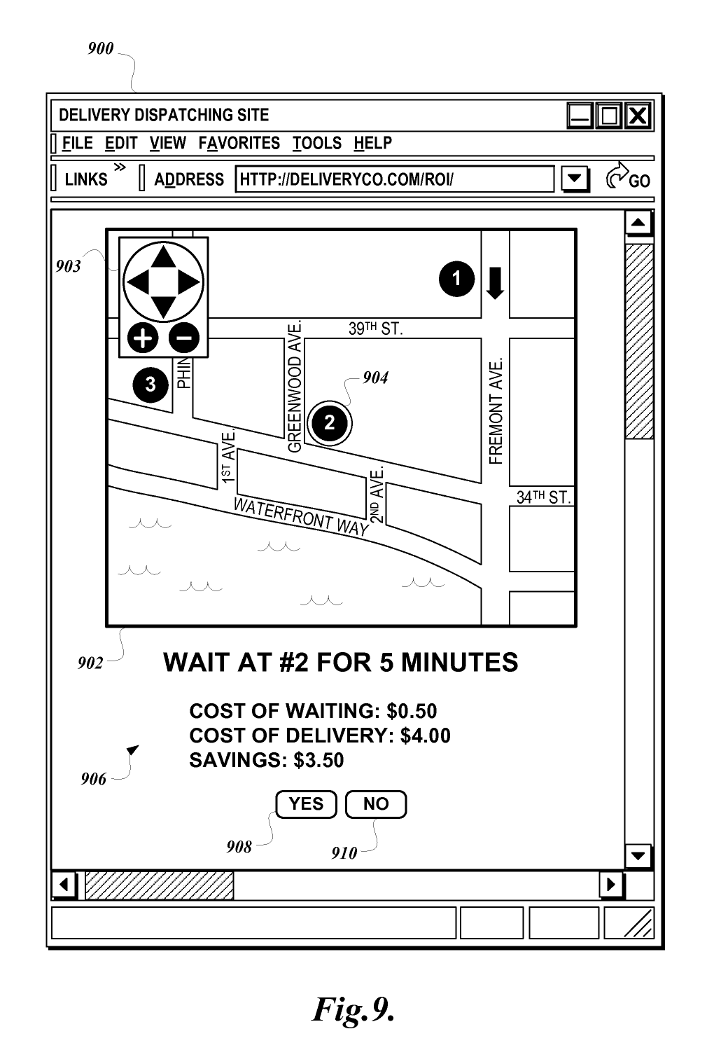

FIG. 9 illustrates an exemplary return on investment interface 900 according to various embodiments of the present disclosure. The return on investment interface 900 is displayed in response to selecting the “calculate” interface button from the new stop interface buttons 816 illustrated in FIG. 8B. The return on investment interface 900 displays a map 902, navigation interface buttons 903, and a proposed new stop location 904. The return on investment interface 900 also displays a return on investment analysis 906 to help a vehicle operator or dispatching agent 526 decide whether to accept or reject the requested rendezvous. For example, in one embodiment, the return on investment analysis 906 will show a comparison in expected cost, based on fuel usage, time cost of labor, and the like, for a successful delivery if the requested rendezvous is successful, versus if the original delivery is reattempted the next day. The return on investment analysis 906 may also take into account the predicted time of arrival and departure from various other stops on the route, which are predicted according to an algorithm discussed above with respect to FIG. 6.

If the return on investment analysis 906 shows that costs can be saved via a successful rendezvous, the vehicle operator or dispatching agent 526 may accept the rendezvous by choosing the new stop acceptance interface button 908. Otherwise, the vehicle operator or dispatching agent 526 may reject the rendezvous by choosing the new stop rejection interface button 910. The return on investment calculations may be used for other purposes, as well, such as determining a cost to assess or an incentive to provide to the package recipient for re-delivery attempts, re-routing, or transferring the package to a third party for delivery. The return on investment interface 900 may also show the cost (or cost savings) of multiple different rendezvous locations, so that a vehicle operator or dispatching agent 526 may pick the most beneficial rendezvous location.

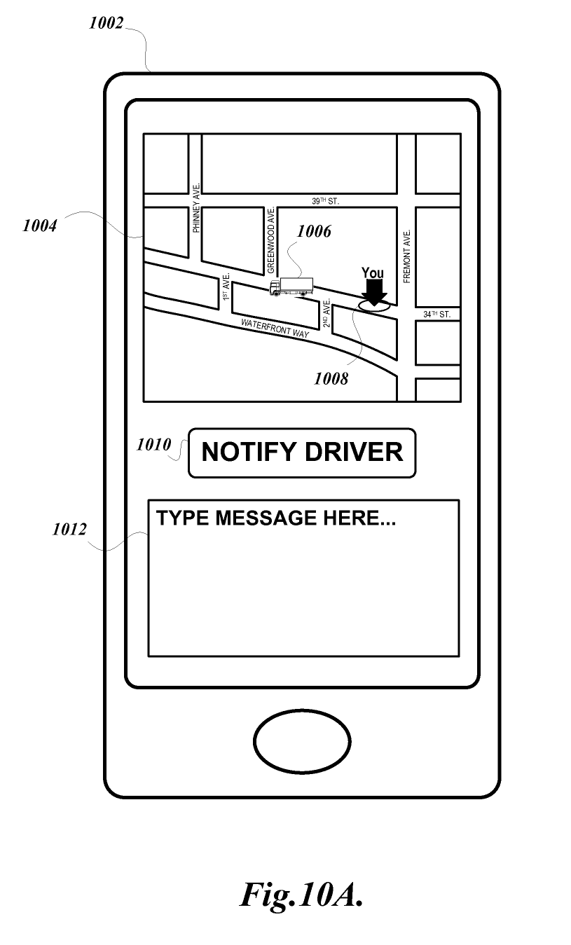

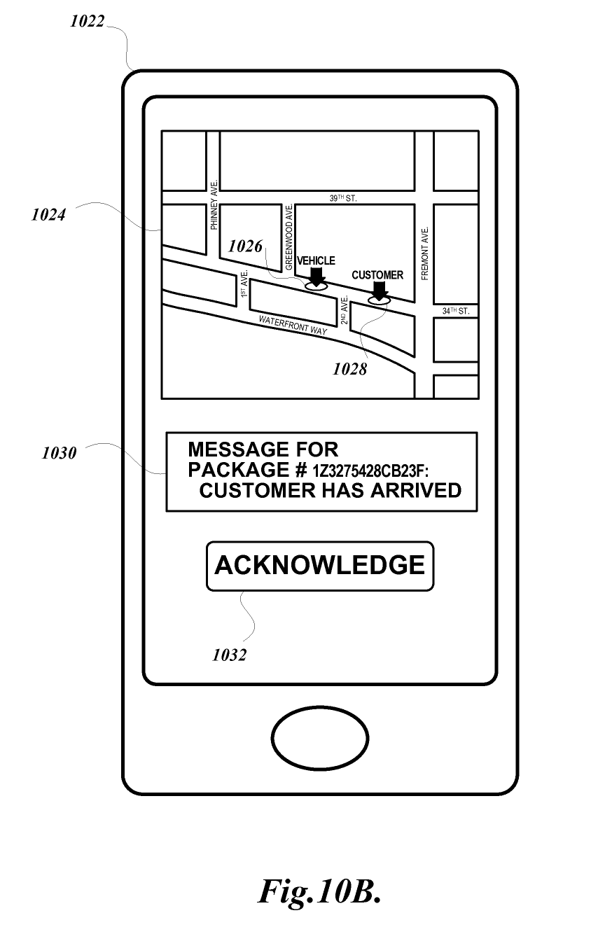

FIG. 10A illustrates one embodiment of an interface presented to a package recipient via a recipient interface device 1002 once the requested rendezvous has been accepted in order to facilitate the rendezvous. In the illustrated embodiment, the recipient interface device 1002 is a mobile device such as a web-enabled smartphone, or a data-enabled phone running a custom application for interfacing with the delivery routing system 500.

The recipient interface device 1002 displays a map 1004, which includes a vehicle location indicator 1006 and a recipient location indicator 1008. The location of the delivery vehicle 306 and the location of the package recipient are tracked by the delivery routing system 500. In one embodiment, the location of the delivery vehicle 306 may be determined by the vehicle interface device 524 via a suitable locating technology, such as GPS, GSM network locating, dead reckoning, and the like. This location may then be transmitted by the vehicle interface device 524 to the delivery interface layer 518. Likewise, in one embodiment, the location of the package recipient may be determined by the recipient interface device 1002 via a suitable locating technology, such as GPS, GSM network locating, and the like, and may then be transmitted by the recipient interface device 1002 to the recipient interface layer 502. Periodic transmission of the location of the recipient interface device 1002 may begin once the rendezvous request is submitted or accepted. In another embodiment, the package recipient may not have a location-enabled mobile device, and may instead manually submit updates indicating a current street address, intersection, distance from the delivery vehicle 306, or the like.

As illustrated, the map 1004 shows that the package recipient is within close proximity to the delivery vehicle 306, as indicated by the vehicle location indicator 1006 and the recipient location indicator 1008. In one embodiment, once the package recipient has been determined to be within a predetermined distance from the delivery vehicle 306, the recipient interface device 1002 may enable a notification interface button 1010, and may also enable a notification message field 1012. Once the package recipient activates the notification interface button 1010, an arrival notification may be sent, along with any message entered into the notification message field 1012, to the vehicle operator via the vehicle interface device 524 or the operator interface device 522. An exemplary process of generating and transmitting the arrival notification will be discussed further below.

FIG. 10B illustrates one embodiment of an interface presented to a vehicle operator via an operator interface device 1022 once an arrival notification has been generated and sent by the package recipient. Similar to the interface presented to the package recipient, this interface may include a map 1024 having a vehicle location indicator 1026 and a recipient location indicator 1028. In one embodiment, the location of the recipient location indictor 1028 may be continuously updated as the package recipient approaches the delivery vehicle 306, so that the vehicle operator may determine at a glance whether a requested rendezvous is likely to occur soon. In one embodiment, the recipient location indicator 1028 may include an estimated time of arrival calculated based on a measured rate of travel of the package recipient and a current location of the package recipient.

A message display 1030 may display one or more arrival notifications generated by the package recipient, or generated automatically once the delivery routing system 500 detects that the package recipient has come within a predetermined distance from the delivery vehicle 306. The display may include a default text string indicating that the recipient has arrived, and may include a message entered into the notification message field 1012 by the package recipient. Once the vehicle operator is ready to meet with the package recipient, the vehicle operator may activate an acknowledgement interface button 1032, which will cause a notification to be generated and sent to the package recipient indicating that the vehicle operator is ready to meet the package recipient. In another embodiment, the vehicle operator may enable the acknowledgement interface button 1032 for a selected period of time. An exemplary process of generating the acknowledgement notification will be discussed further below.

Though the interfaces illustrated in FIGS. 10A and 10B are depicted as providing only minimal communication between the package recipient and the vehicle operator for the sake of simplicity, in other embodiments further communication between the package recipient and the vehicle operator is enabled by the delivery routing system 500. For example, the recipient interface device 1002 may enable the package recipient to notify the vehicle operator when the package recipient first starts heading for the delivery vehicle, as opposed to first allowing conversation when the package recipient is close to the delivery vehicle. As another example, the recipient interface device 1002 and the operator interface device 1022 may enable two-way communication via SMS, email, voice, video chat, and the like, between the package recipient and the vehicle operator while the package recipient is en route to the delivery vehicle 306. These features may be automated and architected to meet the preferences of the delivery provider. As the delivery routing system 500 guides the two parties to within a predetermined distance, the delivery routing system 500 may then proceed to give specific directions to either party, such as a particular intersection or a particular direction of travel, to further facilitate the meeting.

Each of the interfaces illustrated and described above are exemplary, and should not be construed as limiting. In actual embodiments, the interfaces may have more or less functionality, and may have a different visual design, look, or feel, without departing from the scope of the present disclosure. The interfaces may also be customized to particular package recipients, particular delivery companies, particular interface devices, and the like.

As discussed above, embodiments of the present disclosure are operable to guide a first party, such as a package recipient, and a second party, such as a delivery vehicle, to an eventual rendezvous. Embodiments of the present disclosure may periodically transmit information, authentication, instructions, and other communication to the first party and the second party to help facilitate a crossing of a travel stream of the first party and a travel stream of the second party in a manner acceptable to both parties.

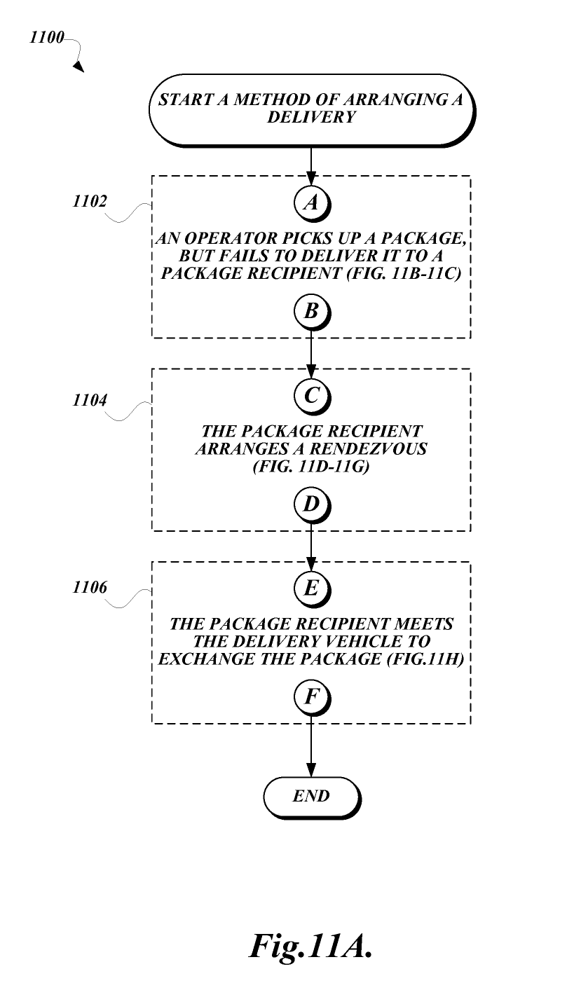

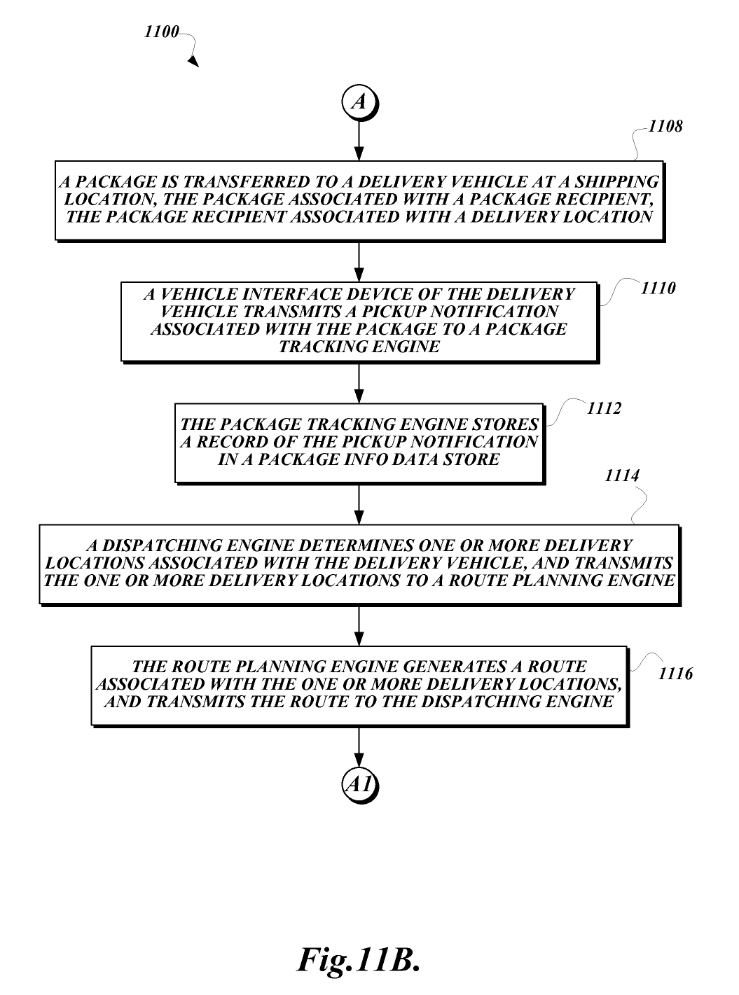

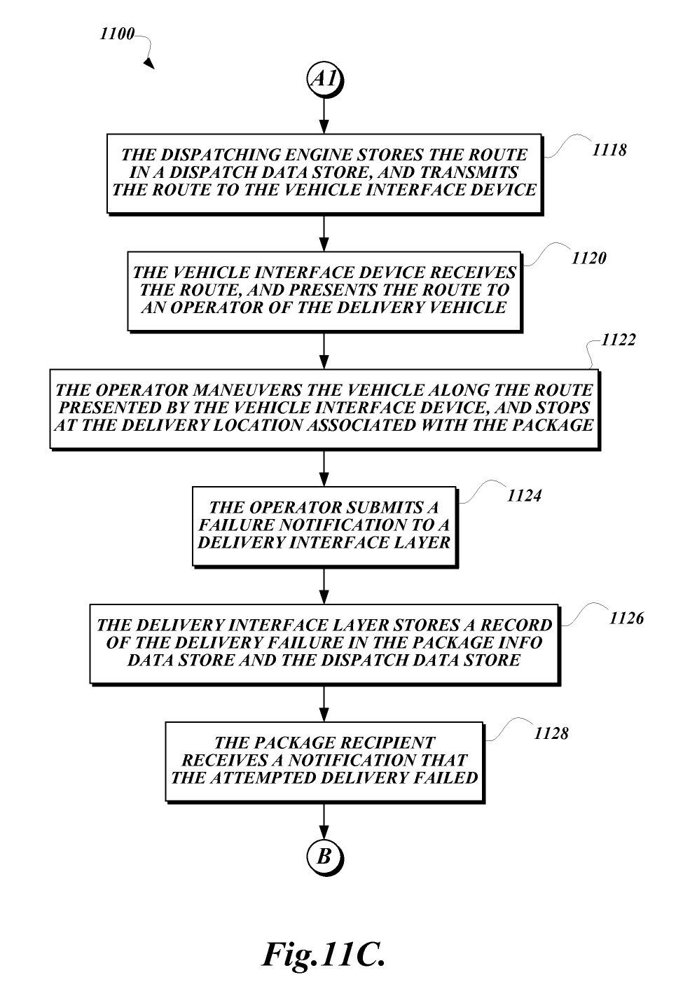

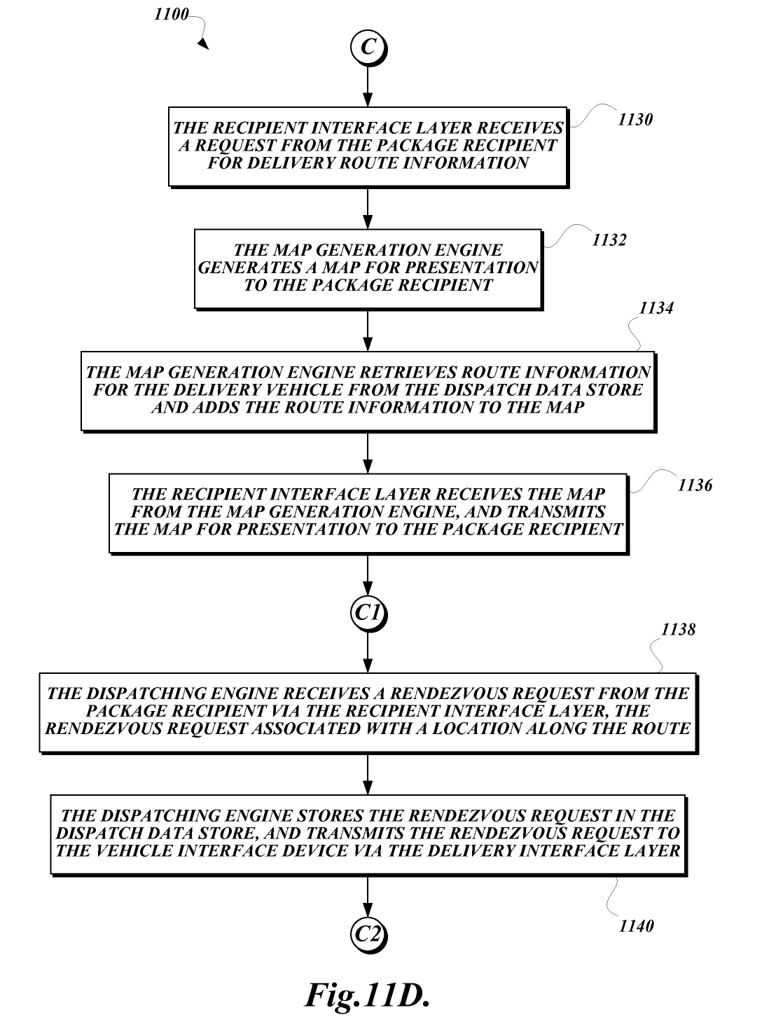

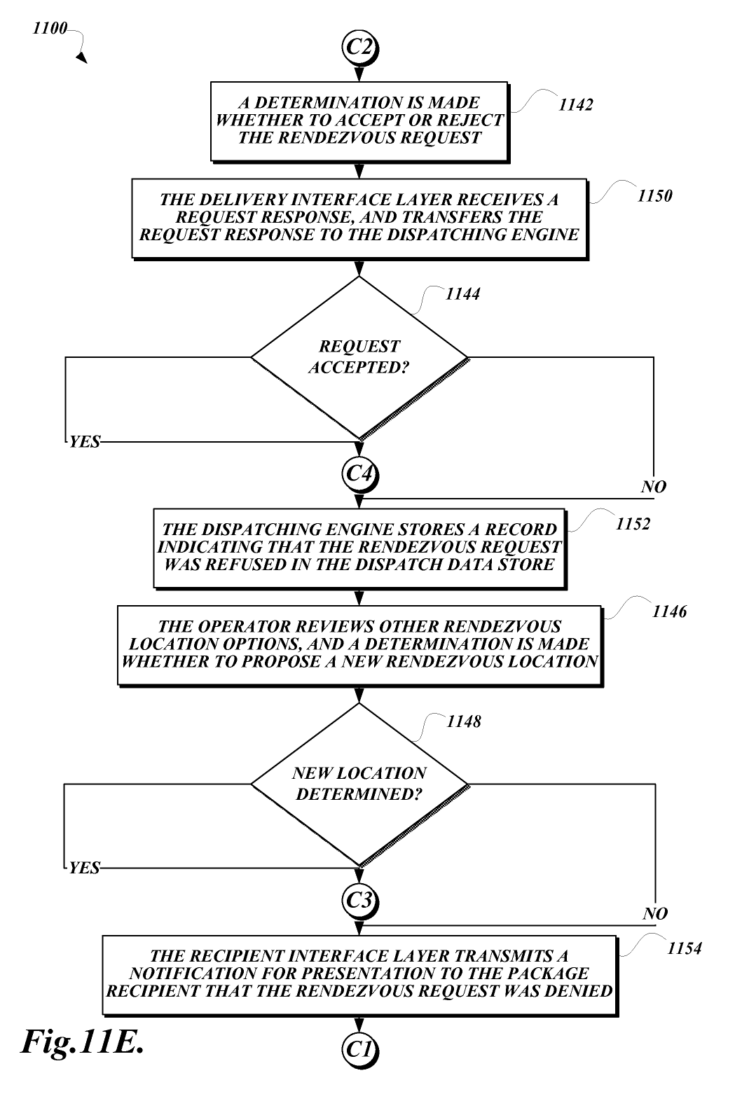

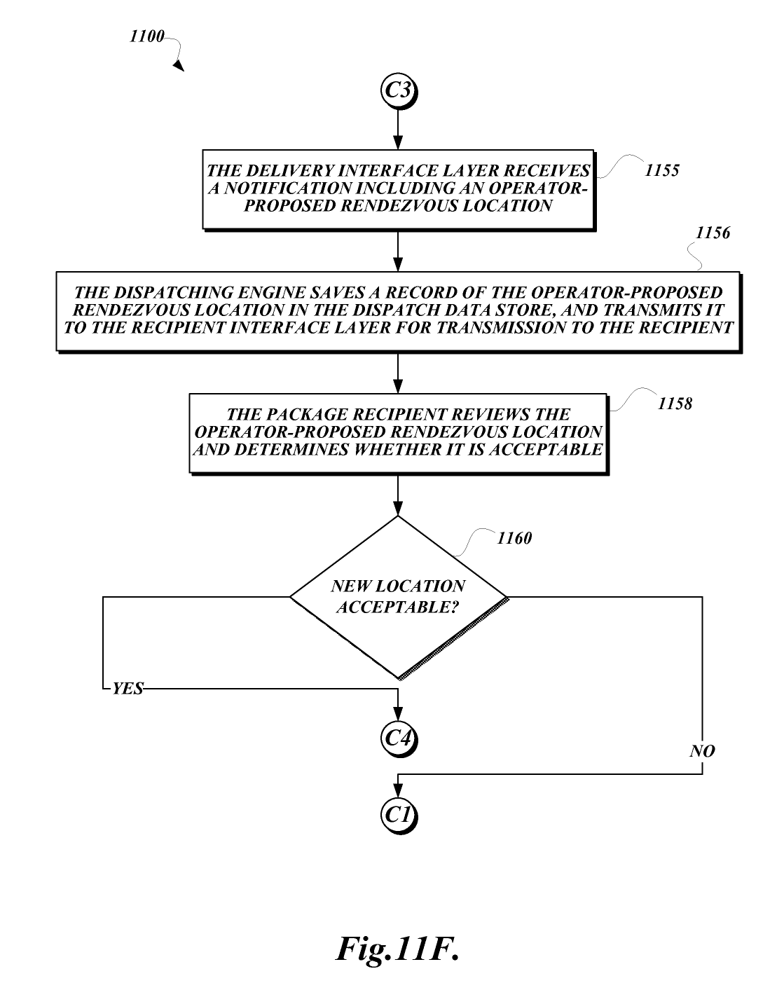

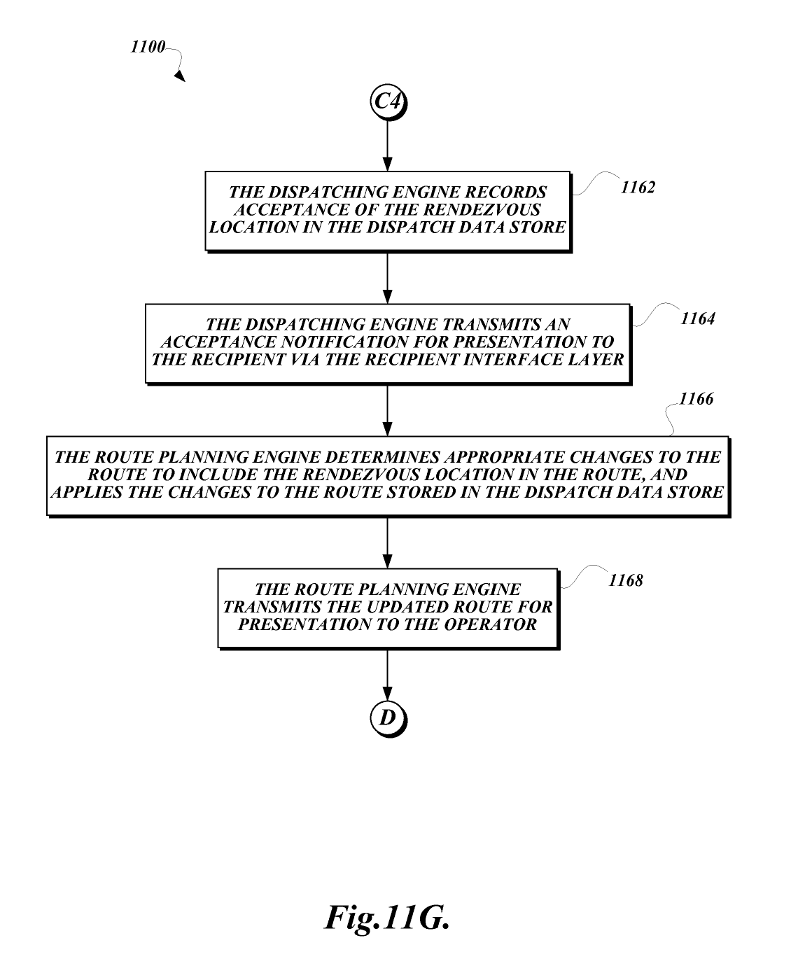

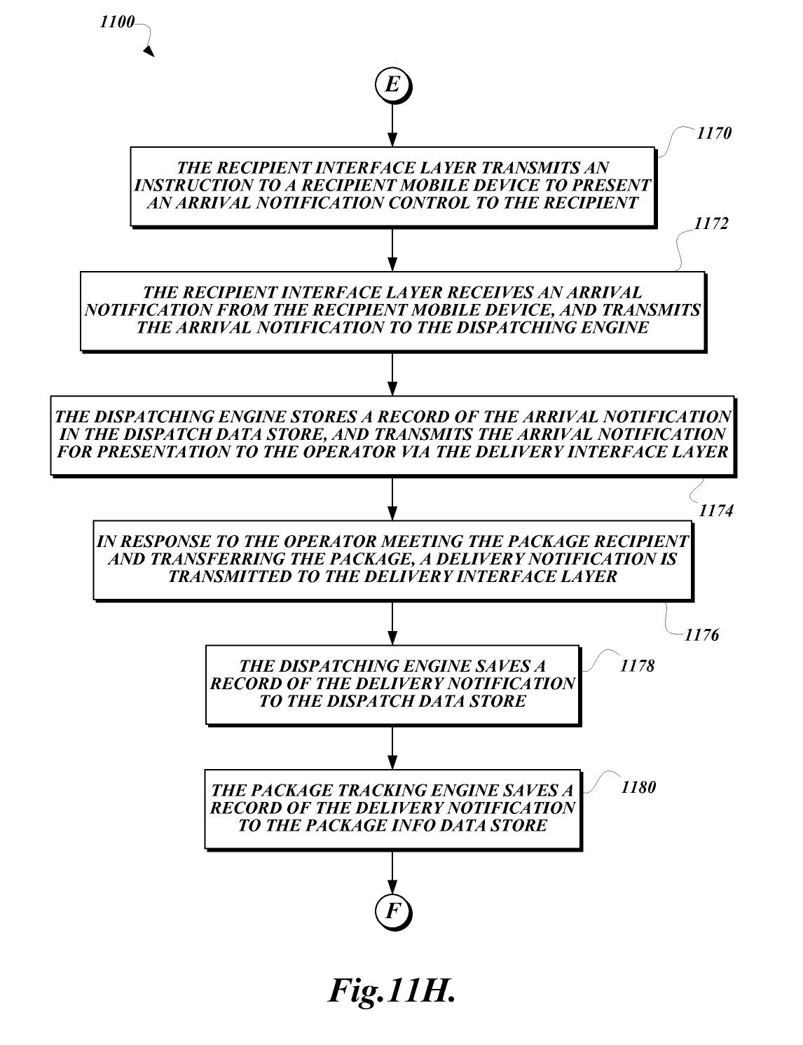

FIGS. 11A-11H illustrate one embodiment of a method 1100 of arranging a delivery according to various embodiments of the present disclosure. From a start block (FIG. 11A), the method 1100 proceeds to a set of method steps 1102 defined between a continuation terminal (“terminal A”) and an exit terminal (“terminal B”). The set of method steps 1102 describe steps in which an operator picks up a package, but fails to deliver the package to a recipient.

From terminal A (FIG. 11B), the method 1100 proceeds to block 1108, where a package is transferred to a delivery vehicle 306 at a shipping location. The package is associated with a package recipient, and the package recipient is associated with a delivery location. In one embodiment, the association between the package and the package recipient may indicate whether a signature from the package recipient is requested for a successful delivery of the package. In another embodiment, it is assumed that some indication of a positive handoff of the package, such as an acknowledgement signature, is requested for a successful delivery. Next, at block 1110, a vehicle interface device 524 of the delivery vehicle 306 transmits a pickup notification associated with the package to a package tracking engine 510. The pickup notification indicates to the delivery routing system 500 that the package has been picked up by the delivery vehicle 306, and that the package is therefore now located within the delivery vehicle 306. The pickup notification may include information such as an identifier of the delivery vehicle 306, an identifier of an operator of the delivery vehicle 306, a timestamp, and the like. The method 1100 then proceeds to block 1112, where the package tracking engine 510 stores a record of the pickup notification in a package information data store 514. Storing the pickup notification in the package information data store 514 enables the recipient interface layer 502 to share the information from the pickup notification with the package recipient, upon request. In one embodiment, the method 1100 repeats the steps described in block 1108 to block 1112 for a plurality of packages transferred to the delivery vehicle 306.

Next, at block 1114, a dispatching engine 512 determines one or more delivery locations associated with the delivery vehicle 306, and transmits the one or more delivery locations to a route planning engine 504. In one embodiment, the dispatching engine 512 determines the one or more delivery locations associated with the delivery vehicle 306 by submitting a query to the package information data store 514 for each package that has been picked up by the delivery vehicle 306, and by receiving the identity of each package, along with the delivery location associated with each package, in response to the query.

The method 1100 then proceeds to block 1116, where the route planning engine 504 generates a route associated with the one or more delivery locations, and transmits the route to the dispatching engine 512. In one embodiment, the route planning engine 504 may use street map information to determine the fastest or shortest route that connects each of the one or more delivery locations. In addition to street map information, the route planning engine 504 may also consider a route start location, a route end location, traffic information, terrain, parking availability, weather information, scheduled stop information, scheduled operator break times, and the like to determine an order in which the one or more delivery locations are visited during the route, as well as to determine the route itself.

In one embodiment, the route planning engine 504 may not merely determine a route that stops at each of the one or more delivery locations, but may instead attempt to combine two or more delivery locations into a cluster. If the route planning engine 504 determines that two or more delivery locations are close enough to one another to provide a positive return on investment by having the vehicle operator deliver each of the packages without moving the delivery vehicle, such as two houses on the same block, two offices in the same building, and the like, the route planning engine 504 may create a cluster stop on the route instead of discrete stops for each of the two or more close delivery locations.

The method 1100 then continues to a continuation terminal (“terminal A1”). From terminal A1 (FIG. 11C), the method 1100 continues to block 1118, where the dispatching engine 512 stores the route in a dispatch data store 516, and transmits the route to the vehicle interface device 524. Storing the route in the dispatch data store 516 instead of recalculating the route each time it is requested ensures that the same route is displayed each time it is requested, instead of risking the possibility that transient conditions such as real-time traffic information alter the calculated route for a given set of one or more delivery locations. Storing the route in the dispatch data store 516 also saves computing time that would otherwise be used in recalculating the route for each request.

Next, at block 1120, the vehicle interface device 524 receives the route, and presents the route to an operator of the delivery vehicle 306. In one embodiment, the route is presented to the operator of the delivery vehicle 306 similar to a standard GPS navigation turn-by-turn interface, which automatically guides the operator through the route step by step. In another embodiment, the overall route is presented to the operator of the delivery vehicle 306 on a map display that may be manually zoomed, moved, and the like, by the operator. The method 1100 proceeds to block 1122, where the operator maneuvers the delivery vehicle 306 along the route presented by the vehicle interface device 524, and stops at the delivery location associated with the package.

At this point, the operator discovers that the delivery is not possible. For example, in a case where a signature is requested for successful delivery of the package, the operator may discover that the package recipient is not available at the delivery location to provide the requested signature, such as a case where the delivery location is a house and there is no one home. Accordingly, the method 1100 then proceeds to block 1124, where the operator submits a failure notification to a delivery interface layer 518. In one embodiment, the operator may submit the failure notification via the operator interface device 522 after using the operator interface device 522 to scan an identifier on the package. In another embodiment, the operator may submit the failure notification via the operator interface device 522 or the vehicle interface device 524 after manually selecting the package from a displayed list of packages. In one embodiment, the operator may also generate a door slip for notifying the package recipient about the delivery failure, and may leave the door slip at the delivery location.

Next, at block 1126, the delivery interface layer 518 stores a record of the delivery failure in the package information data store 514 and the dispatch data store 516. In one embodiment, the record in the package information data store 514 enables the package tracking engine 510 to notify the package recipient of the delivery failure. In one embodiment, the record in the dispatch data store 516 enables the dispatching engine 512 to consider failed delivery stop in a case where the route is to be recalculated, and to track the progress of the delivery vehicle 306 along the route. The method 1100 then proceeds to block 1128, where the package recipient receives a notification that the attempted delivery failed. In one embodiment, receiving the notification may include receiving the door slip left by the operator. In another embodiment, the communication engine 506 may generate a push notification, email notification, or the like for transmission to a recipient interface device 520 via the recipient interface layer 502 upon detecting the delivery failure.

Next, the method 1100 proceeds to terminal B, and then to another set of method steps 1104 (FIG. 11A) defined between a continuation terminal (“terminal C”) and an exit terminal (“terminal D”). The set of method steps 1104 describe steps in which the package recipient arranges a rendezvous.

From terminal C (FIG. 11D), the method 1100 proceeds to block 1130, where the recipient interface layer 502 receives a request from the package recipient for delivery route information. In one embodiment, this request may be received through package recipient interaction with an interface generated by the recipient interface layer. For example, the request may be generated when the package recipient inputs package tracking information from the door slip into the interface. In another embodiment, the request may be automatically generated by the recipient interface device 520 upon receiving a delivery failure notification.

The method 1100 then proceeds to block 1132 where, in response to the recipient interface layer 1102 receiving the request, the map generation engine 508 generates a map for presentation to the package recipient. In one embodiment, the map generation engine 508 generates a map depicting an area in the vicinity of the delivery location. In another embodiment, the map generation engine 508 generates a map depicting an area that includes a portion of the delivery route that includes the delivery location. In yet another embodiment, the map generation engine 508 generates a map depicting an area that includes one or more delivery stops that are closest to the delivery location. The map generated for each of these embodiments may depict similar or overlapping areas, but may depict different areas depending on the initial parameters considered. Next, at block 1134, the map generation engine retrieves route information for the delivery vehicle 306 from the dispatch data store 516 and adds the route information to the map. In one embodiment, the route information may include discrete delivery stop information, and may include estimated times of arrival for each delivery stop. In one embodiment, the route information may include the path to be traveled between delivery stops, along with estimated times at which the delivery vehicle 306 will arrive at indicated points on the path. The method 1100 then proceeds to block 1136, where the recipient interface layer 502 receives the map from the map generation engine 508, and transmits the map for presentation to the package recipient.

The method 1100 next proceeds to a continuation terminal (“terminal C1”), and then to block 1138, where the dispatching engine 512 receives a rendezvous request from the package recipient via the recipient interface layer 502. The rendezvous request is associated with a location along the route, and indicates that the package recipient would like to meet the delivery vehicle 306 at the location to pick up the package for which the delivery failed. The location may coincide with a previously scheduled delivery stop along the route. Alternatively, the location may be a recipient-specified location along the route which was not previously scheduled as a delivery stop, or may be a recipient-specified location that is not yet along the route. In yet another embodiment, the rendezvous request may not include a rendezvous location at all, but instead simply indicates the package recipient's desire to meet the delivery vehicle 306 at some undetermined point along the route. The rendezvous request may also include a time at which the package recipient would like to meet the delivery vehicle 306. Next, at block 1140, the dispatching engine 512 stores the rendezvous request in the dispatch data store 516, and transmits the rendezvous request to the vehicle interface device 524 via the delivery interface layer 518. In one embodiment, the rendezvous request may be transmitted to the operator interface device 522 in addition to, or instead of, to the vehicle interface device 524. In another embodiment, the rendezvous request may be presented in an interface provided by the delivery interface layer 518 to a dispatching agent 526. The method 1100 then proceeds to a continuation terminal (“terminal C2”).

From terminal C2 (FIG. 11E), the method 1100 proceeds to block 1142, where a determination is made whether to accept or reject the rendezvous request. In one embodiment, a reviewing party considers one or more factors in making the determination. As noted above, the reviewing party may be a dispatching agent 526, or may be the operator of the vehicle.

In one embodiment, the reviewing party may consult a return-on-investment calculation, such as the calculation discussed with respect to FIG. 9, when determining whether to accept or reject the rendezvous request. The reviewing party may accept the rendezvous request when the cost savings of doing so are above a threshold. In one embodiment, the reviewing party may take factors into account other than the return on investment, such as a number of rendezvous requests previously granted for the route, whether or not the vehicle is currently on schedule according to the planned route, whether the vehicle is currently traversing an early portion of the route or a later portion of the route, and the like. In another embodiment, the operator or dispatching agent 526 may not be involved in the determination of whether to accept or reject the rendezvous request, and instead the dispatching engine 512 considers one or more of the above factors in automatically accepting or denying the rendezvous request.

Next, at block 1150, the delivery interface layer 518 receives a rendezvous request response, and transmits the rendezvous request response to the dispatching engine 512. In one embodiment wherein the dispatching engine 512 automatically accepts or rejects the rendezvous request, the dispatching engine 512 itself generates the rendezvous request response and does not receive the response from the delivery interface layer 518. The method 1100 then proceeds to decision block 1144, where a test is performed to determine whether the rendezvous request was accepted or denied. In one embodiment, this test is performed by inspecting information contained within the rendezvous request response. If the answer to the test at decision block 1144 is YES, the method 1100 proceeds to a continuation terminal (“terminal C4”).

Otherwise, if the answer to the test at decision block 1144 is NO, the method 1100 proceeds to block 1152, where the dispatching engine 512 stores a record indicating that the rendezvous request was refused in the dispatch data store 516. Next, at block 1146, the operator reviews other rendezvous location options, and a determination is made whether to propose a new rendezvous location. As with the other actions described as being performed by the operator, this determination may be performed by the vehicle operator, by a dispatching agent 526, or automatically by the dispatching engine 512. The new rendezvous location may be selected for any reason, such as parking availability, convenience with respect to the remainder of the delivery route, improved return on investment, and the like.

The method 1100 then proceeds to decision block 1148, where a test is performed to determine whether a new rendezvous location was determined. If the answer to the test at decision block 1148 is YES, the method 1100 proceeds to a continuation terminal (“terminal C3”). Otherwise, if the answer to the test at decision block 1148 is NO, the method 1100 proceeds to block 1154, where the recipient interface layer 502 transmits a notification for presentation to the package recipient that the rendezvous request was denied. In the illustrated embodiment, the method 1100 proceeds to terminal C1, wherein the package recipient may attempt to submit another rendezvous request (see FIG. 11D). In another embodiment, the method 1100 may terminate at this point, instead of allowing the package recipient to submit another rendezvous request. In yet another embodiment, the method 1100 may allow a predetermined number of additional rendezvous requests before terminating.

From terminal C3 (FIG. 11F), the method 1100 proceeds to block 1155, where the delivery interface layer 518 receives a notification including an operator-proposed rendezvous location. In one embodiment, the notification may include more than one operator-proposed rendezvous location, from which the package recipient will be allowed to select. Next, at block 1156, the dispatching engine 512, having received the notification including the operator-proposed rendezvous location from the delivery interface layer 518, saves a record of the operator-proposed rendezvous location in the dispatch data store 516, and transmits it to the recipient interface layer 502 for transmission to the package recipient. In one embodiment, the dispatching engine 512 may replace or update the original rendezvous request with the new operator-proposed rendezvous location. In another embodiment, the dispatching engine 512 may store an indication that the original rendezvous request was rejected while storing the record of the new operator-proposed rendezvous location.

The method 1100 then proceeds to block 1158, where the package recipient reviews the operator-proposed rendezvous location and determines whether it is acceptable. Next, at decision block 1160, a test is performed to determine whether the operator-proposed rendezvous location is acceptable to the package recipient. If the answer to the test at decision block 1160 is YES, the method 1100 proceeds to a continuation terminal (“terminal C4”). Otherwise, if the answer to the test at decision block 1160 is NO, the method 1100 proceeds to terminal C1, wherein the package recipient may repeat the process of submitting a rendezvous request. As with the actions following block 1154, in one embodiment, the method 1100 may terminate if the answer to the test at decision block 1160 is NO, instead of allowing the package recipient to repeat the process of submitting a rendezvous request.

In one embodiment, the steps between block 1146 and block 1160, in which the operator is given the opportunity to propose a rendezvous location, are optional. In this embodiment, the method 1100 may proceed directly from block 1152, wherein the record indicating that the rendezvous request was refused is stored in the dispatch data store 516, to block 1154, wherein the recipient interface layer 502 transmits the notification to the package recipient that the rendezvous request was denied.

From terminal C4 (FIG. 11G), the dispatching engine 512 records acceptance of the rendezvous location, whether initially proposed by the package recipient or by the operator, in the dispatch data store 516. Next, at block 1164, the dispatching engine 512 transmits an acceptance notification for presentation to the recipient via the recipient interface layer 502. This acceptance notification may be in the form of a notification on an interface, such as a web interface, generated by the recipient interface layer 502. In one embodiment, the recipient interface layer 502 may use the communication engine 506 to generate a push notification, an email, an SMS, or the like for delivery and presentation to the package recipient to notify the package recipient of the acceptance.

The method 1100 then proceeds to block 1166, wherein the route planning engine 504 determines appropriate changes to the route to include the rendezvous location in the route, and applies the changes to the route stored in the dispatch data store 516. Next, at block 1168, the route planning engine 504 transmits the updated route for presentation to the operator. The route planning engine 504 may transmit the information for presentation via the operator interface device 522 or the vehicle interface device 524. In one embodiment, the delivery interface layer 518 receives the route from the route planning engine 504, retrieves an appropriate map from the map generation engine 508, and transmits the map with the route superimposed thereon. In another embodiment, the delivery interface layer 518 may transmit the updated route information directly to the vehicle interface device 524 or the operator interface device 522, and the receiving device applies the updates to a displayed map or route.

Recalculating the route or accepting the rendezvous request may include specifying a maximum amount of time for the rendezvous, or may include specifying an end time for the rendezvous. If the rendezvous is not completed before the maximum amount of time elapses, or before the end time for the rendezvous, the vehicle operator proceeds along the route and a notification may be sent to the package recipient that the rendezvous was not successful. Once the failure notification is received, the package recipient may return to terminal C1 to submit a new rendezvous request. In one embodiment, the recipient interface layer 502 may continually provide vehicle location information to the package recipient even if the delivery vehicle 306 is not at a rendezvous location or a delivery stop, and the package recipient may meet the delivery vehicle 306 later in the route without formally submitting a new rendezvous request.

The method 1100 then proceeds to terminal D. Though the above discussion has related primarily to embodiments in which a package recipient has received a delivery failure notice, in another embodiment, the package recipient may arrange a rendezvous before a delivery attempt has been made. For example, if the package recipient has previously obtained the package tracking number, the package recipient may begin their portion of the method 1100 at terminal C by entering the package tracking number into an interface provided by the recipient interface layer 502. This may bypass the portions of the method 1100 relating to the delivery failure and generation of the delivery failure notification, and the rendezvous may be arranged during a portion of the route before the delivery vehicle 306 reaches the original delivery location.

From terminal D, the method 1100 proceeds to another set of method steps 1106 (FIG. 11A) defined between a continuation terminal (“terminal E”) and an exit terminal (“terminal F”). The set of method steps 1106 describe steps in which the recipient meets the delivery vehicle to exchange the package.

Form terminal E (FIG. 11H), the method 1100 proceeds to block 1170, where the recipient interface layer 502 transmits an instruction to a recipient mobile device to present an arrival notification control to the recipient. The arrival notification control may be similar to the notification interface button 1010 illustrated in FIG. 10A. In one embodiment, the recipient interface layer 502 may periodically receive position notifications from the recipient mobile device, and may transmit the instruction to present the arrival notification control once the recipient mobile device has entered a predetermined area near the delivery vehicle 306. For example, in one embodiment, the recipient interface layer 502 may not cause the arrival notification control to be presented (or enabled) until the package recipient and the recipient mobile device have approached to within one block of the delivery vehicle 306.

Next, at block 1172, the recipient interface layer 502 receives an arrival notification from the recipient mobile device, and transmits the arrival notification to the dispatching engine 512. The method 1100 then proceeds to block 1174, where the dispatching engine 512 stores a record of the arrival notification in the dispatch data store 516, and transmits the arrival notification for presentation to the operator via the delivery interface layer 518.

At this point, the package recipient arrives at the delivery vehicle 306, and obtains the package from the vehicle operator. The operator interface device 522 may provide information to the vehicle operator to help the vehicle operator authenticate a person who has arrived at the delivery vehicle 306 as the legitimate recipient of the package. For example, the operator interface device 522 may present a sample signature, a picture of the package recipient, a piece of information such as a portion of a credit card number that provably identifies the package recipient, or the like. As another example, the delivery routing system 500 itself may authenticate the person who has arrived at the delivery vehicle 306 via the detected GPS location of the recipient interface device 520.

Next, at block 1176, in response to the vehicle operator meeting the package recipient and transferring the package, a delivery notification is transmitted to the delivery interface layer 518. The delivery notification includes information pertinent to the delivery of the package, such as the package identifier, a time of the delivery, a location at which the delivery was consummated, a signature captured from the package recipient, and the like. In one embodiment, the delivery notification may be generated and transmitted by the operator interface device 522, which may also assist in scanning a package identifier, recording the time and location of delivery, obtaining the signature from the package recipient, and the like.

Next, at block 1178, the dispatching engine 512, having received the delivery notification from the delivery interface layer 518, saves a record of the delivery notification to the dispatch data store 516. This record may serve to allow the route planning engine 504, the dispatching engine 512, or the map generation engine 508 to take the successful delivery of the package into account when further updating the route for the delivery vehicle 306. The method 1100 then proceeds to block 1180, where the package tracking engine 510, having also received the delivery notification from the delivery interface layer 518, saves a record of the delivery notification to the package information data store 514. This record may serve as the delivery receipt, similar to a receipt that would have been generated had the package been successfully delivered to the original delivery location. From block 1180, the method 1100 proceeds to terminal F, and terminates.

Though the delivery routing system 500 discussed above has been described primarily in regard to arranging a time and location to meet a delivery vehicle to consummate delivery of a package, embodiments of the delivery routing system 500 may also be used to intercept other types of vehicles that travel on routes determined by a dispatcher. For example, the delivery routing system 500 could be used for public transit. A bus, shared-ride van, ferry, or the like would take the place of the delivery vehicle 306, and a rider would take the place of a package recipient. The delivery routing system 500 may help the rider to find a closest transit option to their present location, and may also help the rider communicate with an operator of the transit vehicle to ensure that the transit vehicle will wait for them at an agreed-upon stop location. Similarly, the delivery routing system 500 could be used for the dispatching of taxicabs and the like.

As described above, using the delivery routing system 500 may be quite effective to save labor, fuel, and environmental costs in the event of delivery failures. To further encourage use of the delivery routing system 500, in some embodiments, incentives may be offered to package recipients for successfully arranging a rendezvous. For example, a financial incentive, a discount, a credit in a rewards program, and the like could be awarded to the package recipient in the event of a successful rendezvous. As another example, the dispatching agent 526 or vehicle operator may be able to specify an amount of the reward, and may choose to share a portion of the calculated cost savings with the package recipient as the reward. The reward value amount may be determined and displayed as part of the return on investment interface 900 discussed above, and may be determined automatically or may be specified by the vehicle operator or dispatching agent 526.

In some embodiments, the various components of the delivery routing system 500 may be used in other ways that also may save the delivery company and the package recipients time and costs. For example, a package recipient may be able to use an interface provided by the delivery routing system 500 to notify the delivery routing system 500 that they will not be available at the original delivery location, and therefore a scheduled delivery will not be successful. The delivery company may then cancel the scheduled delivery before making the delivery attempt, thereby saving time and cost. The delivery company may also provide package recipients an incentive, as described above, for providing such information that allows the delivery company to save costs by canceling the scheduled delivery. The delivery routing system 500 may also allow the package recipient to change the destination of the package while the package is on the delivery vehicle 306 for delivery. The return on investment calculation may be used to determine how much a package recipient should be charged (or how much incentive should be provided to a package recipient) for making such a request. Also, the features that allow a package recipient to track the location of a delivery vehicle 306 may be used to help the package recipient choose a new destination that would be easiest or least costly for the delivery vehicle 306 to use.

While illustrative embodiments have been illustrated and described, it will be appreciated that various changes can be made therein without departing from the spirit and scope of the disclosure.

1. A computer-implemented method for facilitating a rendezvous with a vehicle, the method comprising:
receiving a rendezvous request from a rendezvous requester;
determining whether to accept or reject the rendezvous request; and
in response to a determination that the rendezvous request is accepted, transmitting the accepted rendezvous request to a computing device for presentation to a vehicle operator.

2. (canceled)

3. The method of claim 1, further comprising:
transmitting, to a computing device associated with the rendezvous requester, a map including one or more proposed rendezvous locations.

4. The method of claim 1, wherein determining whether to accept or reject the rendezvous request includes calculating a difference in cost between accepting the rendezvous request and rejecting the rendezvous request.

5. The method of claim 1, wherein determining whether to accept or reject the rendezvous request includes transmitting the rendezvous request for presentation to a dispatching agent for review.

6-7. (canceled)

8. A nontransitory computer-readable medium having computer-executable instructions stored thereon that, in response to execution by a processor of a computing device, cause the computing device to perform actions for facilitating a rendezvous between a package recipient and a delivery vehicle, the actions comprising:
receiving a rendezvous request from the package recipient, the rendezvous request including a rendezvous location;
determining whether to accept or reject the rendezvous request; and
in response to a determination that the rendezvous request is accepted:
transmitting the accepted rendezvous request to a computing device associated with the delivery vehicle for presentation to a vehicle operator.

9. The computer-readable medium of claim 8, wherein the actions further comprise:
in response to a determination that the rendezvous request is not accepted:
transmitting an alternate rendezvous location to the package recipient.

10. The computer-readable medium of claim 8, wherein the actions further comprise:
transmitting, to a computing device associated with the package recipient, a map including one or more proposed rendezvous locations.

11. The computer-readable medium of claim 8, wherein determining whether to accept or reject the rendezvous request includes calculating a difference in cost between accepting the rendezvous request and rejecting the rendezvous request.

12. The computer-readable medium of claim 8, wherein determining whether to accept or reject the rendezvous request includes determining whether to assess an additional charge to the package recipient for accepting the rendezvous request.

13-14. (canceled)

15. A system for facilitating package delivery, the system comprising:
a processor;
a computer-readable medium; and
a set of computer-executable components stored on the computer-readable medium for execution by the processor, the computer-executable components including a dispatching engine configured to:
receive a rendezvous request from a package recipient;
receive a rendezvous request response, wherein the rendezvous request response indicates acceptance of the rendezvous request, rejection of the rendezvous request, an additional charge for acceptance of the rendezvous request, or an alternative rendezvous location; and
in response to a rendezvous request response indicating acceptance of the rendezvous request:
transmit an acceptance notification for presentation to the package recipient;
track a location of the package recipient and a location of a delivery vehicle; and
enable a notification interface button on a recipient interface device in response to determining that the location of the package recipient and the location of the delivery vehicle are within a predetermined distance of each other.

16. The system of claim 15, wherein the computer-executable components further include:
a recipient interface layer configured to generate an interface for presentation on a recipient interface device; and
a delivery interface layer configured to generate an interface for presentation on an operator interface device.

17. (canceled)

18. The system of claim 15, wherein the computer-executable components further include:
a dispatch data store configured to store information for a plurality of delivery vehicles, including suggested route information, scheduled delivery stop information, and information associating one or more packages with each delivery vehicle.

19. The system of claim 15, wherein the computer-executable components further include:
a package tracking engine configured to store and update information within a package information data store in response to receiving notifications that status of package deliveries have changed.

20. The system of claim 15, wherein the computer-executable components further include:
a communication engine configured to facilitate communication between a vehicle operator and the package recipient.
